(19) United States
(12) Patent Application Publication
(10) Pub. No.: US 2024/0342939 A1
(43) Pub. Date: Oct. 17, 2024

(54) SLICING MACHINE FOR FOOD ARTICLES

(71) Applicant: Federico SCALERANDI, Vimercate (MB) (IT)

(72) Inventor: Federico SCALERANDI, Vimercate (MB) (IT)

(21) Appl. No.: 18/682,763

(22) PCT Filed: Jul. 11, 2022
(86) PCT No.: PCT/EP2022/069280

§ 371 Date: Feb. 9, 2024

Related U.S. Application Data
(60) Provisional application No. 63/231,760, filed on Aug. 11, 2021.

(51) Int. Cl. B26D 1/00; B26D 1/28; B26D 7/10; B26D 7/12; B26D 7/26

(52) U.S. Cl. CPC B26D 1/0006; B26D 1/28; B26D 7/10; B26D 7/12; B26D 7/2614; B26D 2001/002; B26D 2001/0033; B26D 2001/006; B26D 2210/02

(57) ABSTRACT

Cutting assembly for a food product high speed slicing machine, the cutting assembly (1) comprising a cutter (10) which is rotative around a central axis (A) and comprises a support disc (11), connected by its center to a drive unit (20) through a central shaft (21) concentric with the central axis (A), and a blade (30) releasably attached to a periphery of the support disc (11) by a fixation device, the blade (30) having a spiral cutting edge (31) lying in a cutting plane perpendicular to the central axis (A) and coplanar with a product holder (2); wherein the blade (30) is a non-closed curved blade; and the cutter (10) includes at least one blade (30), defining at least one independent continuous spiral cutting edge (31) with a ξ ratio of at least thirty in at least most of the spiral cutting edge, so that the cut precision is improved.

### FIELD OF THE INVENTION

A Food article slicing machine includes a reception/weighing station, a food article feed station and a knifeblade apparatus with unique and peculiar blade design, nanometric blade position control, three-dimensional blade calibration/retraction mechanism, replaceable blade edge, replaceable blade body, blade edge sterilization/drying system, air flow air diverters, built-in blade re-sharpening device.

### PROCESS DESCRIPTION

The food article feed station supports one or more food articles for movement along food article paths intersecting the cutting path. The knife blade apparatus cuts the food articles with unique and peculiar effect, it can adjusts tri-dimensionally the distance of the blade relative to the product holder with tolerances below 1 μm, it periodically retracts the blade from the cutting plane to make empty cuts, it allows to re-sharpen and substitute not the whole blade but the blade edge only, it allows to interchange the blade body allowing different/multiple cutting actions per revolution, it manages the blade temperature and its humidity with an induction heating system and external/internal temperature sensors for drying and sterilizing the blade, it improves the slice deposition by handling the air flow with replaceable, product dedicated air diverters, it allows to re-sharpen the blade without removing it from the slicer. The reception/weighing station receives the single slices of product, and it arranges them stacked, shingled or folded, in separated groups or continuously.

### BACKGROUND OF THE INVENTION

Many different kinds of food articles or food products, such as food slabs, food bellies, or food loaves are produced in a wide variety of shapes and sizes. There are meat or cheese loaves made from various meats and dairy derivates, including ham, pork, beef, lamb, turkey, fish and meat-like products like soy. The meat in the food loaf may be in large pieces or may be thoroughly comminuted. These meat loaves come in different shapes (round, square, rectangular, oval, etc.) and in different lengths up to 190 cm or even longer. The cross-sectional sizes of the loaves are quite different; the maximum transverse dimension maybe as small as 4 cm or as large as 30 cm. Loaves of cheese or other foods come in the same great ranges as to composition, shape, length, and transverse size.

Typically, the food loaves are sliced, the slices are grouped in accordance with a particular weight requirement, and the groups of slices are packaged and sold at retail. The number of slices in a group may vary, depending on the size and consistency of the food article and the desire of the producer, the wholesaler, or the retailer. For some products, neatly aligned stacked slice groups are preferred. For others, the slices are shingled or folded so that a purchaser can see a part of every slice through a transparent package.

Food articles can be sliced on slicing machines such as models made available by companies like Weber or Gea.

Our unit, like others, can be configured as an automatically loaded, continuous feed machine, or an automatically loaded, back-clamp or gripper type machine.

For what is concerning the blade apparatus, there are two main systems on the market.
Orbital slicer: This system includes a rotor with planetary movement. With every rotation, the circular blade rotates multiple times on its own. The slicing action benefits from a high draw, because the blade slides horizontally a lot in relation to its vertical penetration in the product. The industry identifies this ratio between the motion tangential to the blade profile and the motion perpendicular to the food as “ξ ratio”. The maximum speed is limited by the transmission mechanism (avg. 600 rpm max).

Thanks to the high ξ temperature regulation of the product and blade profiles require less attention in comparison with the other systems currently used, like the involute slicer or band blade slicer.
Involute slicer: This system uses an asymmetrical external profile of the blade (logarithmic curve) to generate the cutting action and the blade is geared centrally. Because the transmission is simpler, the speed can reach 1500 Rpm. The ξ ratio is much lower than in orbital slicers, this means that the blade profiles must suit exactly each application and the product temperature must be calibrated very precisely. A high speed is necessary to achieve a good cutting action; therefore, involute slicer often include an idle cut rotor, that allows empty cuts to ensure a good slicing and portioning action and to allow sufficient time to transport the portion out of the slicing area into the next aggregate, before slicing the next portion.

In both configurations, the slicing machines are widely known on the market. However, the cutting assembly, object of this application, can slice at the same speed typical of Involute slicers but achieving the same results in terms of quality and product condition forgiveness of the Orbital slicers. Also, our unit allows to increase the maximum dimension and/or number of logs of product to be sliced, it minimizes the time necessary for re-sharpening, it increases the quality of the cut thanks to a tighter tolerance between the blade and the product holder (shear bar), it minimizes the cost of the disposable blades using replaceable blade edges, it ensures the hygiene of the blade assembly even if this presents junction points in between the blade segments, it allows to use multiple blades on the same rotor (achieving unprecedent cutting speed), it favors the use of blades with a higher carbon content without necessarily hard chrome plating them, it improves the slices deposition with replaceable air diverters that are dedicated to the specific product to be sliced, it allows to re-sharpen the blade directly on the machine at the end of the working cycle.

### BRIEF DESCRIPTION OF THE INVENTION

The present invention is directed to a cutting assembly for a food product high speed slicing machine, the cutting assembly comprising:
a cutter which is rotative around a central axis and comprises a support disc, connected by its center to a drive unit through a central shaft concentric with the central axis, and a blade releasably attached to a periphery of the support disc by a fixation device, the blade having a spiral cutting edge lying in a cutting plane perpendicular to the central axis.

In this proposed cutting assembly, the blade is a non-closed curved blade, and the cutter includes at least one blade, defining at least one independent continuous spiral cutting edge with a ξ ratio of at least thirty in at least most of the spiral cutting edge, so that the cut precision is improved.

The high ξ value causes a higher precision in the weight of the slice, less smearing and more intact slices even when these are very thin. Also, a high ξ ratio reduces the need to lower substantially the temperature of the product before cutting it.

The ξ ratio is defined by a longitude of the spiral cutting edge, between two given points thereof, divided by the increase of the distance to the central axis between said two given points.

A ξ ratio equal or above thirty provides a high quality cut, because for each centimeter of the thickness of the food product to be cut, thirty centimeters of the cutting edge slides though the food product, reducing the smearing on the blade and the giveaway of the food product, and reducing the temperature increase in the blade due to the friction.

A ξ ratio equal or above thirty requires a long longitude of spiral cutting edge to cut a food product of a certain thickness, the cutting edge being at least thirty times longer than the maximal thickness of the food product to be cut. For example, to cut a 10 cm thick food product, at least a 300 cm long spiral cutting edge is required. Preferably, the combined longitude of all the spiral cutting edges is of at least 320 cm.

As longer the longitude of the spiral cutting edge, bigger and heavier the cutter.

In traditional orbital slicers, the blade is a circular disc which eccentrically rotates and which, simultaneously also rotates around its center. This closed circular disc has to be entirely removed for resharpening or substitution proposes, its size being limited, among other reasons, by its weight.

In traditional Involute slicers, the blade is a spiral element with an opening on its center, where the support disc is attached, and with the spiral cutting edge defined in an outer edge of the blade. This spiral element has to be entirely removed for resharpening or substitution proposes, its size being limited, among other reasons, by its weight.

According to the proposed invention the blade is not a ring but a non-closed curved blade, i.e. a blade only partially surrounding an open inner region, the blade having an interruption, defined between two opposed ends of the blade, through which the inner region is accessible.

This feature allows the blade to be thin and long and therefore very lightweight, and also to require only a fraction of the material for its production in comparison with the traditional involute blades. According to this, the present invention allows for a cutter with an improved ξ ratio using lightweight blades which can be easily produced, manipulated and replaced.

Preferably, an inner edge of the blade is attached to an outer edge, or an spiral outer edge of the support disc.

The support disc can include a circular central portion and an outer portion releasably attached around the circular central portion and including the fixation device, the spiral outer edge of the support disc being defined on an outer edge of the outer portion. This allows the substitution of only the outer portion and the blade to modify the profile of the spiral cutting edge or to modify the number of independent spiral cutting edges.

According to an embodiment, at least the circular central portion of the support disc includes reinforcement ribs perpendiculars to the cutting plane, increasing the rigidity thereof.

The cutting precision is improved by the stiffness of the blade body.

It is also proposed that each blade can be made of several independent blade segments arranged in uninterrupted succession. Each independent continuous spiral cutting edge is defined by said uninterrupted succession of blade segments, further reducing the weight of each blade segment and making its production easier.

The blades, or the blade segments, can be made of carbon steel with carbon content from about 0.05 up to 3.8 percent by weight, providing a hard and sharp cutting edge. The carbon steel can be fragile, but the support disc provides strength to the cutter.

The cutting assembly can further include a heater and/or an UV lamp associated to the blade for heating and/or irradiate a local region of the blade at each revolution of the cutter. This heating and/or UV irradiation of a local region of the blade on each revolution ensures a continuous disinfection thereof.

The cutting assembly can further include a blade temperature and humidity detector, for example, comprising a first temperature sensor configured to detect the temperature of a local region of the blade, and a second temperature sensor configured to detect the ambient temperature, and a control device configured to determine the humidity present in the blade by the differences between the temperatures measured by the first and second temperature sensors.

Preferably, the cutting assembly includes radial air bearings associated to the central shaft, surrounding a portion of said central shaft providing a tight guiding thereof with an almost nonexistent friction.

The cutting assembly can also include axial air bearings associated to a circular bearing disc or a circular bearing ring rigidly attached to the cutter and/or to the central shaft and concentric to the central axis. The axial air bearing prevents the movement of the cutter in the direction of the central axis.

The use of air bearings, which have nanometric tolerances, improve the cutting precision.

According to an additional embodiment, the support disc includes air diverters associated thereto to generate an air flow directed towards a region for pushing a recently sliced food product slice, to push them away to improve the slice deposition effect.

The support disc can also include an adjustable counterweight, for example a nut around a radial threaded shaft, allowing for a modification of the nut distance to the central shaft, to compensate the blade weight loss after re-sharpening.

Preferably, a blade sharpening device is movable between a inoperative position in which the blade sharpening device is spaced apart from the cutting edge, and an operative position in which the blade sharpening device is in contact with the spiral cutting edge while the spiral cutting edge rotates, automatically adjusting the distance of the blade sharpening device from the central axis, producing the sharpening of the spiral cutting edge. This allows for the sharpening of the blade “in situ” without removing the blade from the machine.

The cutting assembly may further include adjusting configurations adapted to precisely adjust the relative position between the blade and the product holder at least in a direction parallel and/or perpendicular to the central axis. Said adjusting configurations can be associated with the air bearings to adjust the position of the cutting assembly through the adjustment of the air bearings.

Also, the rotation of the blade around an axis perpendicular to the central axis can also be achieved though said adjusting configurations.

According to a second aspect of the present invention, the cutting assembly has the same construction described above but the cutter including several independent blades each defining one independent continuous spiral cutting edge with a ξ ratio of at least fifteen, instead of thirty, in at least most of the spiral cutting edge, so that the cut velocity is improved.

According to that, the cutter includes several independent blades, defining several independent spiral cutting edges, each with a ξ ratio of at least fifteen. Including several spiral cutting edges on the same cutter, all with a ξ ratio of at least fifteen, allows for an increase in the cutting velocity while maintaining an acceptable cut quality for some applications.

### BRIEF DESCRIPTION OF THE FIGURES

The foregoing and other advantages and features will be more fully understood from the following detailed description of an embodiment with reference to the accompanying drawings, to be taken in an illustrative and non-limitative manner, in which:

FIG. 1 shows a schematic cross section of the slicer machine including a cutting assembly, a food feeder to provide the product to be sliced to the product holder of the cutting assembly and also an output conveyor to extract the already sliced product;

FIG. 2 shows a front view of the cutting assembly according to a first embodiment of the present invention with a single blade with an ξ ratio bigger than thirty and a first arrangement of air bearings;

FIG. 3 shows a lateral cross section of the cutting assembly shown in FIG. 2;

FIG. 4 shows a front view of the cutting assembly according to a second embodiment of the present invention with a single blade with an ξ ratio bigger than thirty and a second arrangement of air bearings;

FIG. 5 shows a lateral cross section of the cutting assembly shown in FIG. 4;

FIGS. 6 and 7 show the cutting assembly of FIG. 2 in an initial cutting position and in a final cutting position of the same cutting revolution;

FIG. 8 shows a zoomed front view of a portion of the cutting assembly including one blade segment detached from the correspondent outer portion of the support disc, including two screws as attachment device;

FIGS. 9 and 10 shows a zoomed cross section of the blade segment, the outer portion of the support disc and a portion of the circular central portion of the support disc, in an attached position and in a detached position respectively;

FIG. 11 shows a front view of an alternative embodiment of the cutting assembly including two blades, each with an ξ ratio bigger than thirty;

FIG. 12 shows a front view of an alternative embodiment of the cutting assembly including two blades, each with an ξ ratio between fifteen and thirty.

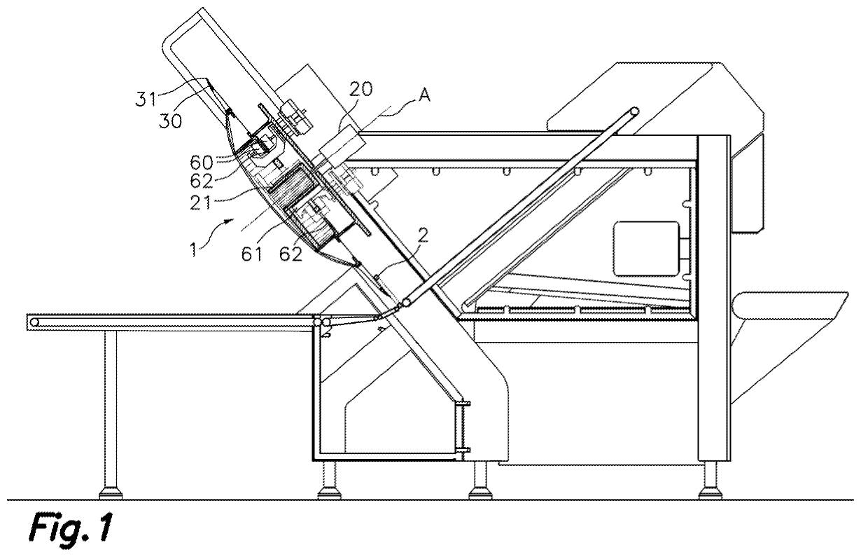

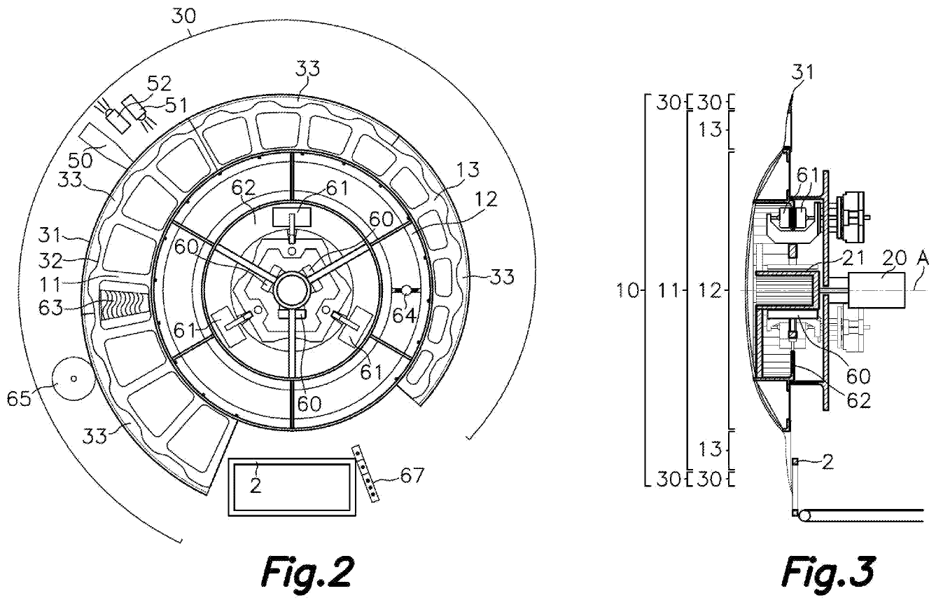

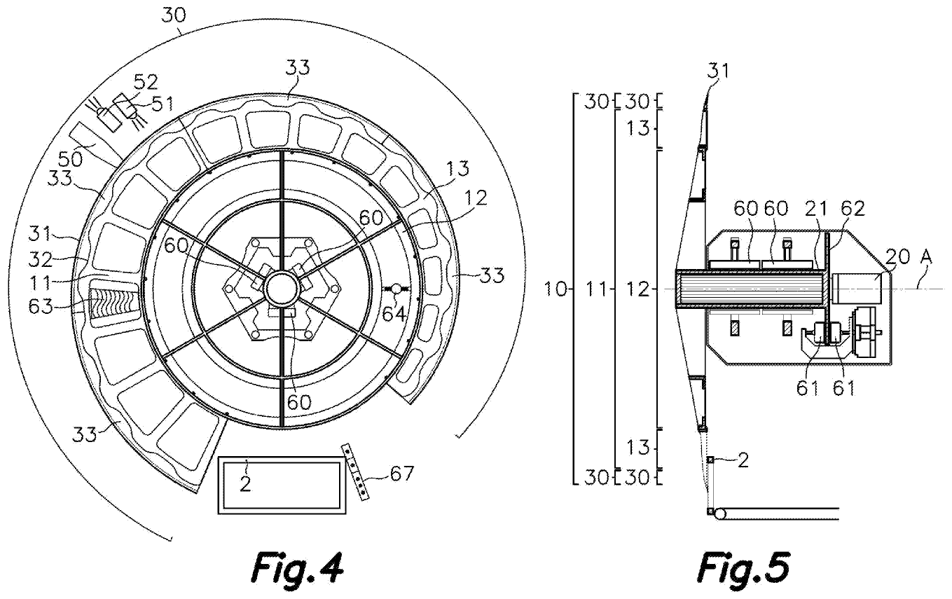

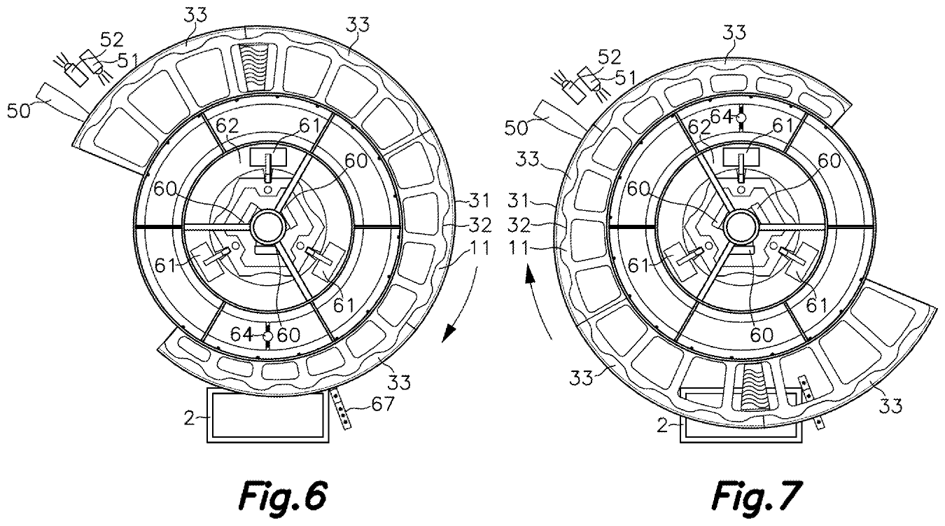

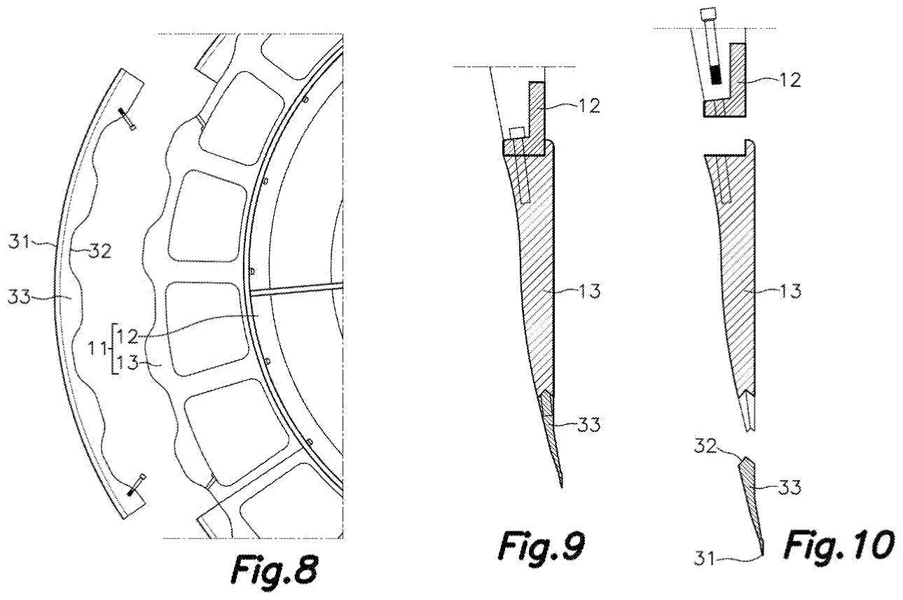

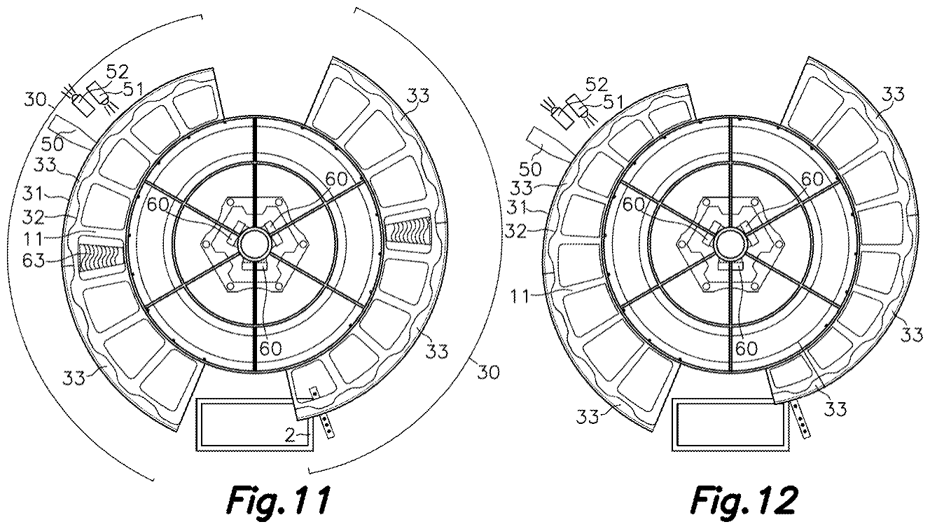

### DESCRIPTION OF THE INVENTION

The present description concentrates on the cutting assembly 1 in its totality, skipping details regarding the food feeder to the cutting assembly and the sliced food receiver and processor, because the food feeder and the sliced food receiver and processor replicate the systems most commonly used in the industry, without innovative differences.

The proposed cutting assembly 1 combines the advantages of an Involute blade (higher speed, larger usable cutting area, better slice placement) and the advantages of an orbital blade (gentler cutting action, no need for crust freezing, no need to adapt the blade edge angle specifically to the product).

This is achieved by using a cutter 10 with a one or several blades 30, each including a cutting edge 31 presenting the typical profile of an involute blade but including one blade with a ξ ratio of at least thirty in at least most of the spiral cutting edge 31, similar to the ξ ratio of an orbital blade, so that the cut precision is improved.

Alternatively, the cutter 10 includes several independent blades 30, each with a ξ ratio of at least fifteen in at least most of the spiral cutting edge, so that the cut velocity is improved.

An involute blade produces one complete cut for every single revolution of the cutter 10 when the cutter 10 includes one blade 30, or several complete cuts for every single revolution of the cutter 10 when the cutter 10 includes several independent blades 30. To obtain such elevated ξ ratios using an involute blade, the total longitude of the cutting edge 31 of the blade 30 of the proposed cutting assembly 1 has to be much longer than the commonly known involute blade, which is typically made of a single metal sheet and therefore its size is limited by its weight.

The ξ ratio of the cutting edge 31 of the proposed cutting assembly 1 is equivalent to the ξ ratio of the of an orbital slicer, which obtain an elevated ξ ratio by passing the same cutting edge for the cutting area several times during each single cut of the orbital slicer, obtained by multiple blade revolutions, but requiring one single pass of the cutting edge for the cutting area during each single cut, obtaining a cutting edge much longer than the typically longitude of the cutting edge of a normal involute blade.

In addition, the length of the cutting edge 31 of the proposed invention brings two other advantages. Having the same low attack angle of an orbital blade, the wear is limited in comparison with an involute blade. But at the same time, it does not perform multiple revolutions per cut, like the orbital blade, with a lastingness advantage also in comparison with this one.

In the long term, this translates into an economic saving, but in the short term it implies also longer production shifts before having to re-sharpen the blade, with an advantage in terms of added production time.

According to a first aspect of the proposed invention, the cutting assembly 1 comprises a rotative cutter, which includes a support disc 11, connected to a drive unit 20 through a central shaft 21, and a blade 30 releasably attached to the support disc 11 through a fixation device.

The cutting edge 31 of the blade 30 of the proposed cutting assembly 1 presents the typical profile of an involute blade. In the preferred embodiments, said cutting edge 31 is defined by a logarithmic curve divided in three sections, each characterized by a specific varying angle.

According to a preferred embodiment, each blade 30 is made of several successive independent blade segments 33, which are connected with the support disc 11 through the fixation device. Those blade segments 33 require less material and can be individually substituted, reducing the maintenance and replacement cost, and due to its size they can be manually handled, accelerating and facilitating its substitution.

Preferably, the support disc 11 comprises a circular central portion 12 and an outer portion 13 releasably attached around the circular central portion 12 through a fixation device.

According to an embodiment, the blade segments 33 are attached to the outer portion 13 of the support disc 11 with a specific blade coupling edge that, in a front view, has a wavy shape and which is complementary to the inner edge 32 of the blade segment 33. Preferably said coupling edge also includes a self-centering configuration, for example with a V-shaped cross section, to ensure the perfect alignment between the blade segments 33 and the outer portion 13.

This wavy-shaped coupling edge increases the contact area and distributes the side load generated by the penetration of the blade 30 into the product in two different radial points of the coupling, one more external and one more internal, improving the structural strength. This is especially appropriate considering that the self-centering configuration does not offer a high degree of containment in itself.

The outer portion 13 of the support disc 11 can be replaced, for example to modify the number of blades 30 attached to the cutter 10, increasing the productivity of the slicer in terms of slices per minute.

In this case, if the vertical penetration in the product is maintained for each blade 30, the ratio of each blade 30 is reduced. This solution can be used in products that don't require great attention to the ξ value, for example using two blades 30 each having an ξ ratio comprised between fifteen and thirty, allowing to process tall products or to increase their radius further, incrementing the usable cutting window of the product holder.

Contrary, the ξ ratio can be maintained despite increasing the number of blades 30 if the vertical penetration is reduced, for example slicing lower height products, maintaining the ξ ratio unaltered.

The blade segments 33 are coupled between each other and with the outer portion of the support disc 11 by means of bolts and the above mentioned self-centering configuration with an V-shaped cross section.

This creates recesses and interstices that can harm the food safety level of the machine. For this reason, the cutting assembly 1 is equipped with a heater 50 (such an inductor) that can heat up the blade 30 to sterilize it before beginning the production shift. To control the action of the heater 50 and therefore the temperature, the cutting assembly 1 is equipped also with a blade temperature and humidity detector 51, 52. This can be achieved, for example, by a first temperature sensor 51, which controls the temperature of the blade 30, and a second temperature sensor 52 which checks the surrounding temperature, for example of a spot on an outer safety cover of the blade 30. The control system can detect if the blade is humid, because a difference in temperature between the temperature measured by the first and second temperature sensors 51, 52 is indicative of evaporation taking place on the blade 30, which cools down its temperature.

The huge diameter of the proposed blade 30 of the cutting assembly 1 requires a higher level of precision for the control of its movement in comparison with smaller competitor blades. This is particularly important if we consider the“scissor effect”, a parameter that indicates the distance between the cutting edge 31 and the product holder 2. The product holder 2 is coplanar with the cutting plane and supports the product to be cut right before the blade cutting plane.

In order to ensure a high precision placement of the cutting edge 31 in regard to the product holder 2 despite the huge diameter of the cutter 10, instead of traditional conical roller bearings, the cutting assembly preferably utilizes aerostatic air bearings 60, 61.

For example, the cutting assembly 1 can comprise at least one cylindrical surface concentric with the central axis A, typically the central shaft 21, surrounded with several radial air bearings 60 providing support in the radial direction. The cutting assembly 1 further includes at least one circular bearing disc or a circular bearing ring 62, orthogonal to the central axis A, with several axial air bearings 61 facing it to provide support in the axial direction.

This technology ensures tolerances between the air bearing and the supported part up to ten times smaller than in high precision roller bearings. The additional advantage is that air bearings 60, 61 are contactless, this means that there's no wear and during time they can ensure the same constant level of precision.

According to a first embodiment of this invention, several couples of axial air bearings 61 are clamping the circular bearing ring 62 in between, each couple of axial air bearings 61 being supported by an independent actuator that can regulate the position into space of the couple of axial air bearing 61, and of the blade 30 therewith, in the axial direction parallel to the central axis A.

Regulating the position into space is necessary to maximise the “scissor effect”, while the axial movement is necessary to stray the blade 30 away from the cutting plane every time that there's an interval between the portions to slice. This allows to generate “empty cuts” to avoid the contact between the blade 30 and the product when there's no need for cutting action, so that the product doesn't get spoiled.

According to a second embodiment of the present invention, the air bearings 60, 61 hold the cutting assembly 1 without the possibility to orientate it into space but keeping the possibility to perform the axial movement in the axial direction parallel to the central axis A that allow “empty cuts”. In this case, to maximize the “scissor effect”, instead of regulating the position into space of the blade 30, we are adjusting tridimensionality the position of the product holder 2 utilizing adjustment screws at the beginning of the working cycle.

In both embodiments the necessary adjustment is controlled by high precision distance sensors 67 (such as nanometric laser distance sensors) that detect the blade position and give an indication of the position changes needed either for the blade 30 or the product holder 2. Said distance sensors 67 will measure at least the distance between the blade 30 and the product holder 2 in the axial direction of the central axis A.

In the present invention, the distance sensors 67, the heater 50 and/or a blade sharpening device 65 can be mounted on a moving support which slides preferably in a radial direction. Such moving support can be placed on the side of the product holder edge, which is a frame surrounding an opening though which the product is exposed to the blade 30. The radial movement of this assembly is operated by an actuator that makes these devices follow the spiral profile of the blade as it spins slowly to perform the laser measuring or the sharpening “in situ” by means of the blade sharpening device 65.

The involute blade has a dislocated shape with a wear side that is correctly balanced only at the beginning of the blade lifetime.

For this reason, there's only a given wear that is considered acceptable before the rotor can suffer from the excessively unbalanced movement. The proposed cutting assembly 1 is equipped with a balancing counterweight 64, for example mounted on a threaded support that can be adjusted to keep the mass of the blade group centered.

The blade angle of the cutting assembly 1 varies like the angle of standard involute blades, therefore with the best slice deposition effect, but our unit presents an improvement that is relevant considering speeds up to 3000 cuts per minute, preferably when several blades 30 are included in the cutting assembly 1.

The outer portion 13 of the support disc 11 may include successive weight reduction through holes. One or several of said weight reduction through holes may include air diverters 63 or aerodynamic deflectors which generate an air flow, due to the rotation of the cutting assembly 1, against the recently cut slices, forcing those slices away. The air diverters 63 or the aerodynamic deflectors may be interchangeable depending on the product as they are shaped specifically for the individual deposition need.

1. Cutting assembly for a food product high speed slicing machine, the cutting assembly comprising:
a cutter which is rotative around a central axis and comprises a support disc with a central shaft concentric with the central axis to be connected to a drive unit when in use, and a blade releasably attached to a periphery of the support disc by a fixation device, the blade having a spiral cutting edge lying in a cutting plane perpendicular to the central axis and coplanar with a product holder;
characterized in that
the blade is a non-closed curved blade; and
the cutter includes at least one blade, defining at least one independent continuous spiral cutting edge with a ξ ratio of at least thirty in at least most of the spiral cutting edge, and/or defining a combined longitude of all the spiral cutting edges of at least 320 cm, so that the cut precision is improved.

2. (canceled)

3. The cutting assembly according to claim 1 wherein an inner edge of the blade is attached to an outer edge of the support disc or to a spiral an outer edge of the support disc.

4. The cutting assembly according to claim 3 wherein
the support disc includes a circular central portion and an outer portion releasably attached around the circular central portion and including the fixation device, the outer edge of the support disc being defined on an outer edge of the outer portion; or
the support disc includes a circular central portion and an outer portion releasably attached around the circular central portion and including the fixation device, the outer edge of the support disc being defined on an outer edge of the outer portion, and at least the circular central portion includes reinforcement ribs perpendiculars to the cutting plane.

5. The cutting assembly according to claim 1 wherein each blade is made of several independent blade segments arranged in uninterrupted succession.

6. The cutting assembly according to claim 1 wherein each blade is made of carbon steel with carbon content from about 0.05 up to 3.8 percent by weight.

7. The cutting assembly according to claim wherein the cutting assembly further includes:
a heater and/or an UV lamp associated to the blade for heating and/or for irradiating a local region of the blade at each revolution of the cutter; or
a heater and/or an UV lamp associated to the blade for heating and/or for irradiating a local region of the blade at each revolution of the cutter and a blade temperature and humidity detector; or
a heater and/or an UV lamp associated to the blade for heating and/or for irradiating a local region of the blade at each revolution of the cutter and a blade temperature and humidity detector, wherein the blade temperature and humidity detector comprises a first temperature sensor configured to detect the temperature of a local region of the blade, and a second temperature sensor configured to detect the ambient temperature, and a control device configured to determine the humidity present in the blade by the differences between the temperatures measured by the first and second temperature sensors.

8. The cutting assembly according to claim wherein the cutting assembly includes radial air bearings associated to the central shaft and/or axial air bearings associated to a circular bearing ring rigidly attached to the cutter and/or to the central shaft thereof and orthogonal and concentric to the central axis.

9. The cutting assembly according to claim wherein the cutting assembly and/or the product holder further includes adjusting configurations adapted to precisely adjust the relative position between the blade and the product holder at least in a direction parallel and/or perpendicular to the central axis.

10. The cutting assembly according to claim wherein the support disc includes air diverters associated thereto to generate an air flow directed towards a region for pushing a recently sliced food product slice, and/or wherein the support disc includes an adjustable counterweight.

11. The cutting assembly according to claim wherein a blade sharpening device is movable between a inoperative position in which the blade sharpening device is spaced apart from the cutting edge, and an operative position in which the blade sharpening device is in contact with the spiral cutting edge while the spiral cutting edge rotates, automatically adjusting the distance of the blade sharpening device from the central axis to follow the spiral cutting edge, producing the sharpening of the spiral cutting edge.

12. Cutting assembly for a food product high speed slicing machine, the cutting assembly comprising:
a cutter which is rotative around a central axis and comprises a support disc with a central shaft concentric with the central axis to be connected to a drive unit when in use, and a blade releasably attached to a periphery of the support disc by a fixation device, the blade having a spiral cutting edge lying in a cutting plane perpendicular to the central axis and coplanar with a product holder;
characterized in that
the blade is a non-closed curved blade; and
the cutter includes several independent blades each defining one independent continuous spiral cutting edge with a ξ ratio of at least fifteen in at least most of the spiral cutting edge, and/or defining a combined longitude of all the spiral cutting edges of at least 320 cm, so that the cut velocity is improved.

13. (canceled)

14. The cutting assembly according to claim 12 wherein an inner edge of the blades is attached to an outer edge of the support disc or to a spiral outer edge of the support disc.

15. The cutting assembly according to claim wherein
the support disc includes a circular central portion and an outer portion releasably attached around the circular central portion and including the fixation device, the outer edge of the support disc being defined on an outer edge of the outer portion, or
the support disc includes a circular central portion and an outer portion releasably attached around the circular central portion and including the fixation device, the outer edge of the support disc being defined on an outer edge of the outer portion, and at least the circular central portion includes reinforcement ribs perpendiculars to the cutting plane.

16. The cutting assembly according to claim 15 wherein each blade is made of several independent blade segments arranged in uninterrupted succession.

17. The cutting assembly according to claim 15 wherein the blades are made of carbon steel with carbon content from about 0.05 up to 3.8 percent by weight.

18. The cutting assembly according to claim 15 wherein the cutting assembly further includes:
a heater and/or an UV lamp associated to the blade for heating and/or for irradiating a local region of the blade at each revolution of the cutter; or
a heater and/or an UV lamp associated to the blade for heating and/or for irradiating a local region of the blade at each revolution of the cutter, and a blade temperature and humidity detector; or
a heater and/or an UV lamp associated to the blade for heating and/or for irradiating a local region of the blade at each revolution of the cutter, and a blade temperature and humidity detector wherein the blade temperature and humidity detector comprises a first temperature sensor configured to detect the temperature of a local region of the blade, and a second temperature sensor configured to detect the ambient temperature, and a control device configured to determine the humidity present in the blade by the differences between the temperatures measured by the first and second temperature sensors.

19. The cutting assembly according to claim 13 wherein the cutting assembly includes radial air bearings associated to the central shaft and/or axial air bearings associated to a circular bearing ring rigidly attached to the cutter and/or to the central shaft and concentric to the central axis.

20. The cutting assembly according to claim 12 wherein the cutting assembly and/or the product holder further includes adjusting configurations adapted to precisely adjust the relative position between the blade and the product holder at least in a direction parallel and/or perpendicular to the central axis.

21. The cutting assembly according to claim 12 wherein the support disc includes air diverters associated thereto to generate an air flow directed towards a region for pushing a recently sliced food product slice, and/or wherein the support disc includes an adjustable counterweight.

22. The cutting assembly according to claim 12 wherein a blade sharpening device is movable between an inoperative position in which the blade sharpening device is spaced apart from the cutting edge, and an operative position in which the blade sharpening device is in contact with the spiral cutting edge while the spiral cutting edge rotates, automatically adjusting the distance of the blade sharpening device from the central axis to follow the spiral cutting edge, producing the sharpening of the spiral cutting edge.
